(19) United States
(12) Patent Application Publication
(10) Pub. No.: US 2012/0140331 A1
(43) Pub. Date: Jun. 7, 2012

(54) METHOD FOR FABRICATING MICRO-LENS, AND MICRO-LENS ARRAY INCLUDING THE MICRO-LENS

(76) Inventors: Young Je YUN, Seoul (KR); Jin Ho Park, Seoul (KR)

(21) Appl. No.: 13/163,125

(22) Filed: Jun. 17, 2011

(30) Foreign Application Priority Data
Dec. 1, 2010 (KR) 10-2010-0121265

(51) Int. Cl. G02B 27/12; B05D 5/06

(52) U.S. Cl. 359/619; 427/162

(57) ABSTRACT

A method for fabricating a micro-lens includes forming a photo-resist film on and/or over a micro-lens formation area of a semiconductor substrate, and then forming a portion of the photo-resist film as a first micro-lens using a first gray-tone mask. A second micro-lens is then formed adjacent to the first micro-lens using another portion of the photo-resist film and a second gray-tone mask.

The present invention claims priority to Korean Patent Application No. 10-2010-0121265 (filed on Dec. 1, 2010), which is hereby incorporated by reference in its entirety.

### BACKGROUND

Generally, thermal reflow is one of the techniques most widely employed in a process for forming a micro-lens array of an image sensor. Thermal reflow applies heat to a photo-resist pattern to reflow it to thus obtain a lens foam having a desired curvature.

During use of thermal reflow, however, when a micro-lens in a fluid state comes into contact with a neighbor micro-lens during the reflow process, the micro-lenses in contact tend to conglomerate due to surface tension of the fluid. This makes the micro-lens abruptly bridged with the neighbor micro-lens and the curvature of the bridged micro-lens distorted, which results in a defective micro-lens. Accordingly, the use of the thermal reflow actually makes it difficult to form a perfect zero-gap micro-lens, i.e., without a gap between the micro-lens itself and the neighboring micro-lenses.

FIGS. 1A and 1B illustrate a sequential process of a method for solving the problems in forming the micro-lens and a top-down view of each process in accordance with the related art, respectively.

As illustrated in FIG. 1A, in the related art, in order to solve the bridge problem with the neighboring micro-lens arising in the micro-lens forming process, a photo-resist pattern of a first micro-lens is formed and thermally reflowed. The photo-resist pattern of a second micro-lens is then formed in an empty space on a semiconductor substrate and then thermally reflowed, rather than forming the neighboring micro-lens at a time. Namely, the micro-lens is formed through a 2-step micro-lens forming process or a dual micro-lens forming process.

In such a 2-step micro-lens forming process, the micro-lenses neighboring in a horizontal or vertical direction are formed separately two times, reducing an occurrence of a lens bridge, whereby a perfect zero-gap can be formed.

As illustrated in FIG. 1B, however, when the distance “a” from a micro-lens neighboring in a diagonal direction is zero, a lens bridge is also generated in the diagonal direction. There is a limitation, therefore, in reducing the diameter of the dead zone such that it is smaller than a certain distance. Meaning, in the general 2-step micro-lens forming process, an adjustable diameter of the dead zone is about 0 nm to 300 nm, which is constant regardless of a pixel pitch. Thus, when the ratio between the pixel area and the dead zone area is taken into consideration, additional improvement is required for pixels having a size of less than 1.4 μm.

Meanwhile, when the size of the pixel is reduced to be 1.2 μm or less, optimum lens curvatures of respective red, green, and blue colors should each be different. The existing 2-step micro-lens forming process, however, merely divides the thermal reflow into two steps to simply perform the respective steps separately, and thus, is incapable of forming the respective pixel colors with different curvatures. Accordingly, it is difficult to use this technique to achieve optimization due to an increase in the pixel-tech.

In addition, in the above-noted 2-step micro-lens forming process, the lens shape is formed using thermal reflow in both first and second steps of the micro-lens forming process. In such a case, different optimal conditions need to be sought depending on pixel sizes in the thermal reflow. Consequently, there is a problem in that whenever the pixel size is reduced, the optimization process needs to be performed several times, respectively.

As illustrated in FIG. 2, in order to overcome the limitation of the existing thermal reflow, a micro-lens forming process using a gray-tone mask 200 derived from an MEMS (micro electro mechanical systems) process has recently come to prominence. In the micro-lens forming process using the gray-tone mask 200, a mask pattern is formed as if a dot painting was drawn with dots smaller than resolution, to allow the intensity of transmitted light to be continuously changed depending on the density of dots. A desired curvature is thus obtained only with photolithography.

When a micro-lens array is formed by using the gray-tone mask as illustrated in FIG. 2, a desired curvature can be freely formed for each color since the gray-tone mask is mainly dedicated for forming a lens of a pitch of tens of μm of MEMS. In case of a micro-lens array for an image sensor whose pixel size is merely 1 μm to 2 μm, however, a gap space profile formed between neighboring lenses need to be sharply changed within a distance of about 0.1 μm to 0.2 μm.

The degree of the sharpness of the gap space profile, however, is determined depending on photolithography resolution. As illustrated in FIGS. 3A through 3C, consequently, in a case of photo-resist for a micro-lens using an i-line wavelength, in the micro-lens forming process using the gray-tone mask 310, and an SEM (scanning electron microscope) photograph, a severe gap space rounding 300 is formed to reduce effective curvature of the micro-lens and increase the size of the dead zone at which four lenses are in contact.

### SUMMARY

Embodiments relate to an image sensor, and more particularly, to a micro-lens array and a method for fabricating a micro-lens of an image sensor which implements a micro lens array having a zero dead zone using a gray tone mask in fabricating a micro-lens used for an image sensor, and which generates spherical radiuses of micro-lenses corresponding to respective pixels such that they have different values to thus maximize optical efficiency of colors of the respective pixels.

Embodiments relate to a micro-lens array and a method for fabricating a micro-lens which implements a micro-lens array having a zero dead zone, which is difficult to implement in the existing 2-step micro-lens, using a gray-tone mask, while maintaining the same or a reduced number of processes than the related art, which optimizes a lens curvature for each pixel color which is not possible with thermal reflow, and which effectively prevents the formation of a gap space rounding.

In accordance with embodiments of the present invention, a method for fabricating a micro-lens includes at least the following: forming a photo-resist film on and/or over a micro-lens formation area of a semiconductor substrate; forming a portion of the photo-resist film as a first micro-lens using a first gray-tone mask; and then forming the remaining portion of the photo-resist film as a second micro-lens adjacent to the first micro-lens using a second gray-tone mask.

In accordance with embodiments, the first and second gray-tone masks may include a transmission area for allowing a transmission of light to the photo-resist film and a blocking area for blocking light. Moreover, the density of the blocking area may range from about 20% to 80%. Furthermore, the blocking area may be formed of chromium. In addition, the curvature radius of the first micro-lens may be different from that of the second micro-lens. Also, the curvature radius of a horizontal cut and the curvature of a diagonal cut of each of the first and second micro-lenses may be equal, and the height from a lower layer of the horizontal cut and the height from the lower layer of the diagonal cut may be different from each other. Further, the first and second micro-lenses may be formed to be adjacent in a vertical or horizontal direction. Further still, the first and second gray-tone masks may include a transmission area for allowing a transmission of light to the photo-resist film and a blocking area for blocking light, and the density of the blocking area may range from about 30% to 60%.

In accordance with embodiments of the present invention, a micro-lens array for an image sensor can include at least the following: a first micro-lens; and a second micro-lens adjacent to the first micro-lens and having a curvature radius different from that of the first micro-lens.

In accordance with embodiments, the first and second micro-lenses may be formed adjacent to each other in a vertical or horizontal direction. Moreover, the curvature radius of a horizontal cut and the curvature radius of a diagonal cut of each of the first and second micro-lenses may be equal, and the height from a lower layer of the horizontal cut and the height from a lower layer of the diagonal cut may be different from each other.

### DRAWINGS

FIGS. 1A and 1B illustrate a 2-step micro-lens forming process using a thermal reflow in accordance with the related art.

FIG. 2 illustrates a formation of a micro-lens using a gray-tone mask in accordance with the related art.

FIGS. 3A to 3C illustrate a process of forming a micro-lens using a gray-tone mask and an SEM photograph in accordance with the related art.

Example FIGS. 4A and 4B illustrate a 2-step micro-lens forming process using a gray-tone mask in accordance with embodiments of the present invention.

Example FIG. 5A illustrates a formation of a micro-lens using the gray-tone mask in accordance with embodiments of the present invention.

Example FIG. 5B illustrates the micro-lens taken along line V-V′ in example FIG. 5A.

Example FIG. 6 illustrates an SEM photo of a micro-lens profile obtained by the process of example FIGS. 4A and 4B.

Example FIGS. 7A and 7B illustrate a photomask and an optical simulation graph of the micro-lens profile in example FIG. 6, respectively;

Example FIGS. 8A and 8B illustrate a photo mask having a gray dummy pattern instead of chromium pad in example FIG. 6 and an optical simulation graph of the micro-lens profile thereof, respectively.

Example FIG. 9 is a graph which illustrates the relationship between a chromium density and thickness of a photo-resist in accordance with embodiments of the present invention.

Example FIGS. 10A and 10B illustrate a micro-lens profile achieved by using a photo mask in which the areas where a micro-lens is not formed are formed as the chromium pads, and an improved micro-lens profile achieved by using the gray-tone mask in accordance with embodiments of the present invention, respectively.

Example FIGS. 11A and 11B respectively illustrate SEM photographs of micro-lenses using the gray tone mask illustrated in example FIG. 8A.

Example FIGS. 12A and 12B respectively illustrate a micro-lens SEM photograph and curvature radius through a thermal reflow process, and the micro-lens SEM photograph and the curvature radius through the gray-tone mask process, in accordance with embodiments of the present invention.

### DESCRIPTION

Hereinafter, embodiments of the present invention will be described in detail with reference to the accompanying drawings which form a part hereof. In the following description, well-known functions or constitutions will not be described in detail if they would obscure embodiments of the invention in unnecessary detail. Further, the terminologies to be described below are defined in consideration of functions in accordance with embodiments of the present invention and may vary depending on a user's or operator's intention or practice. The definitions, therefore, need to be understood based on all the contents of the specification.

Example FIGS. 4A and 4B illustrate a 2-step micro-lens forming process using a gray-tone mask in accordance with embodiments of the present invention.

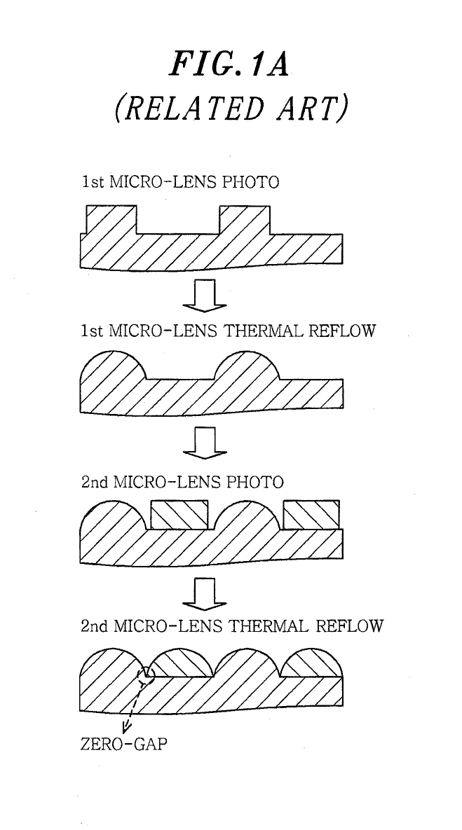

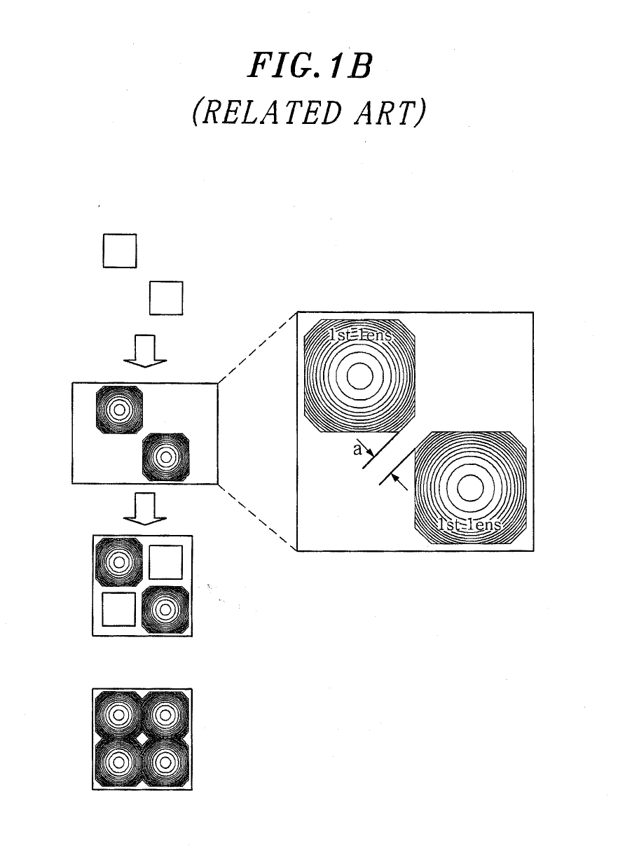

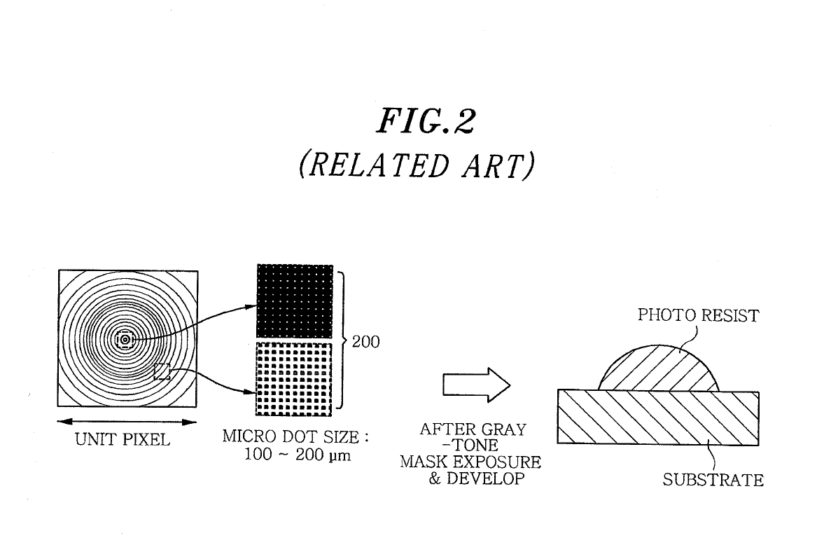

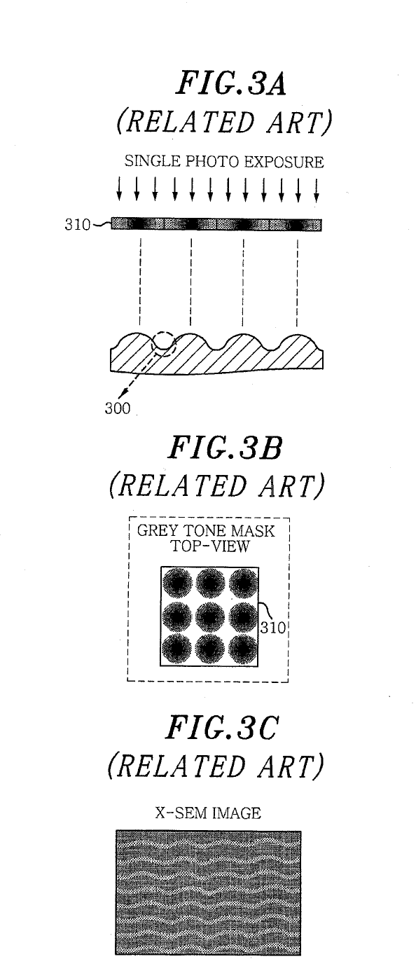

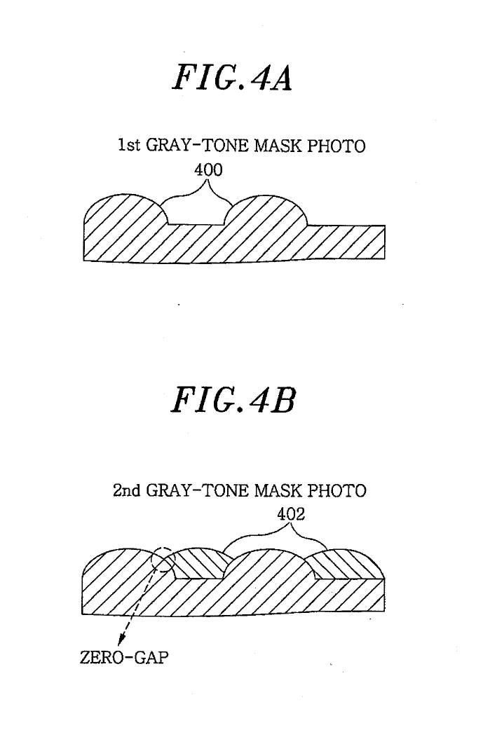

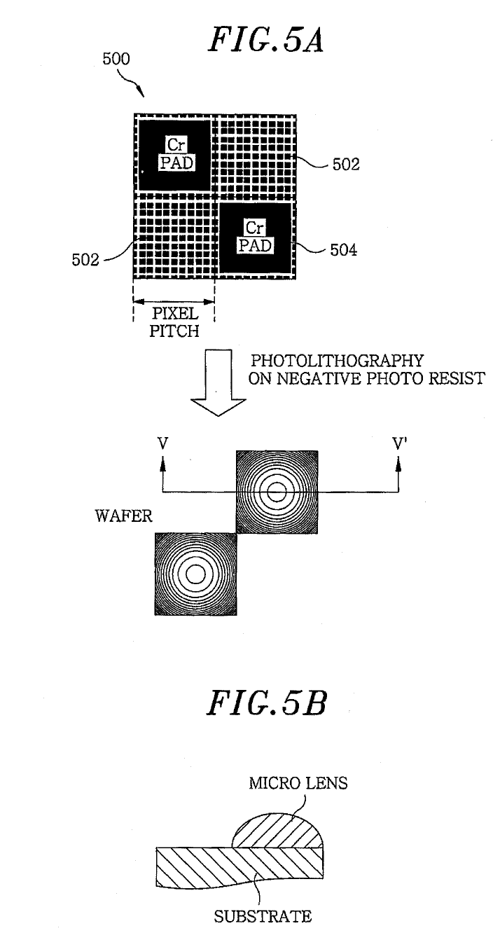

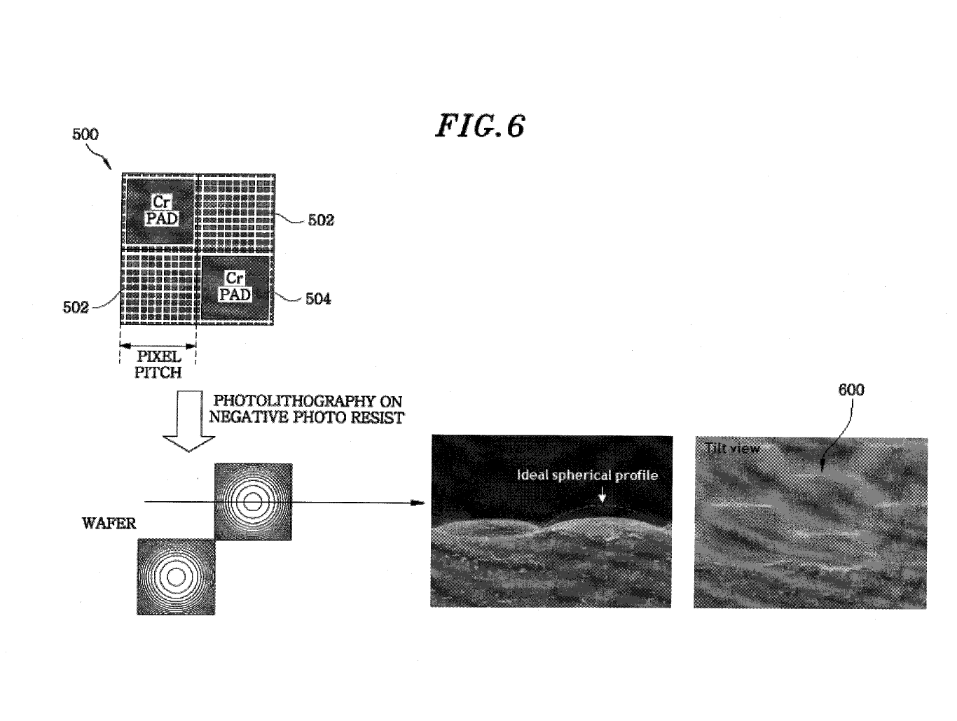

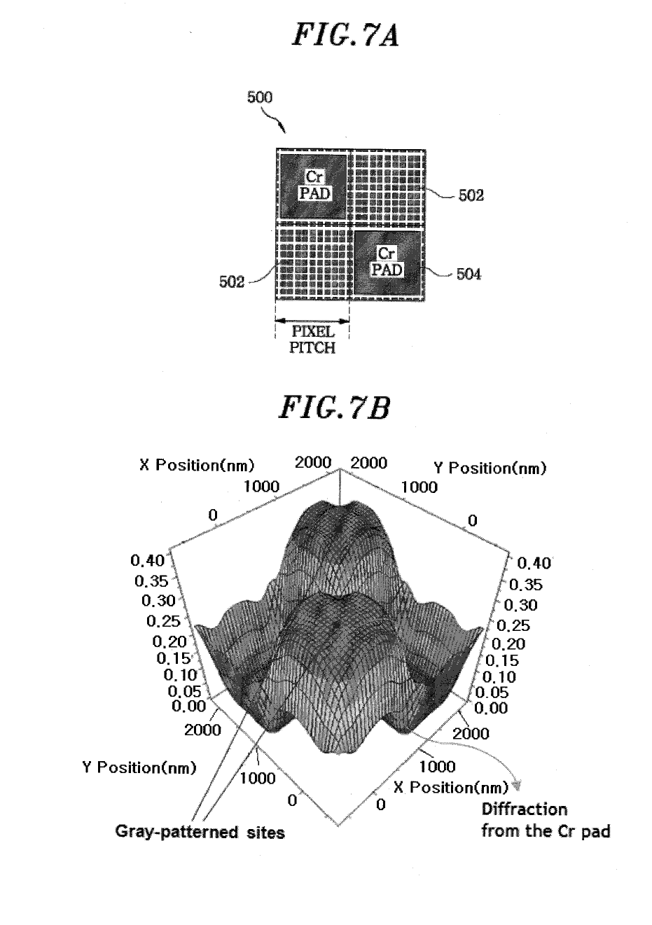

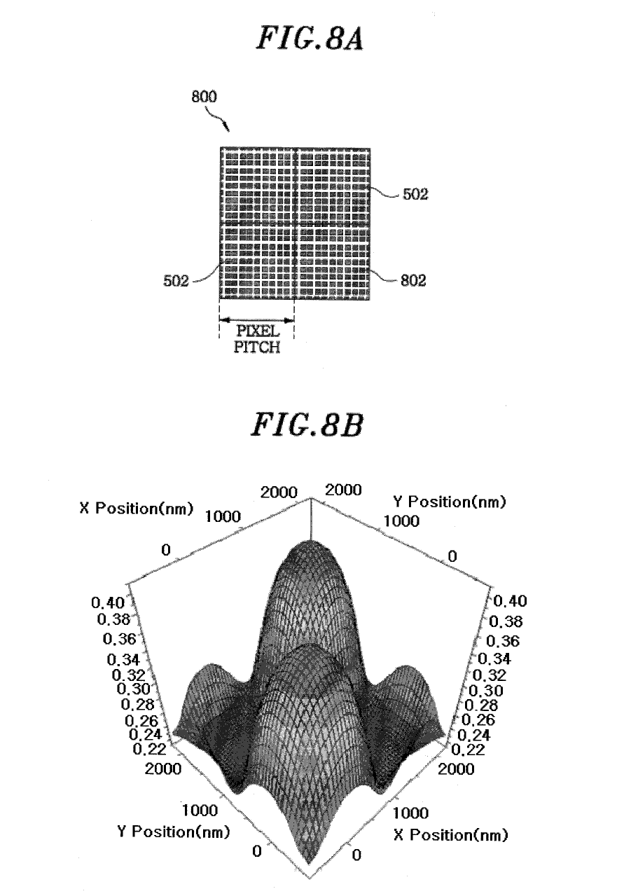

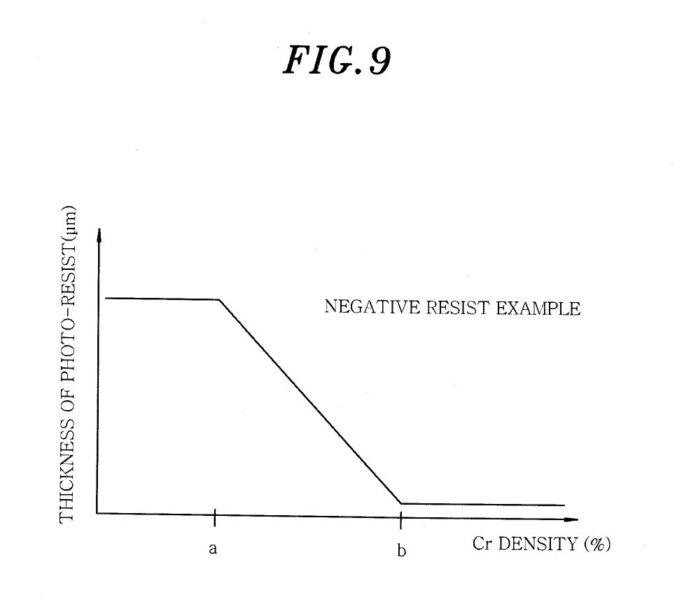

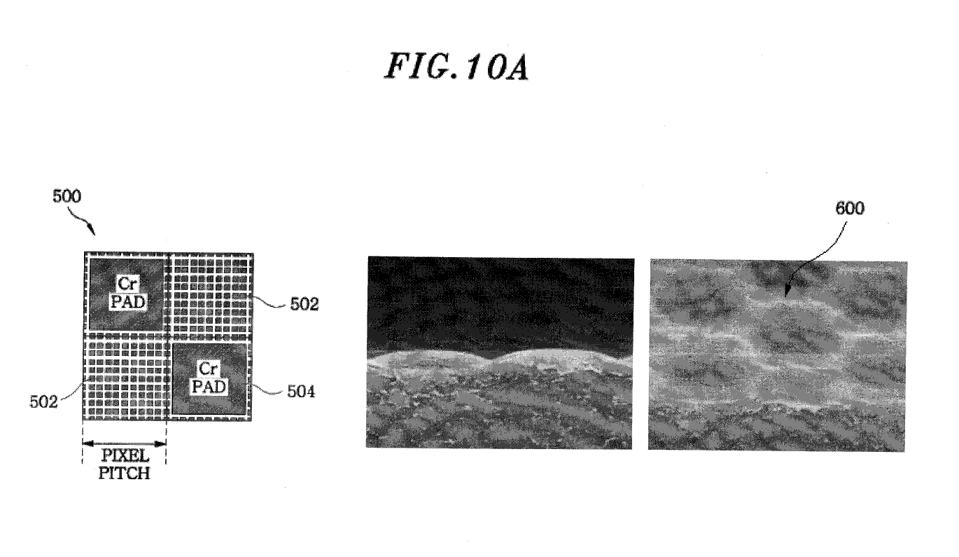

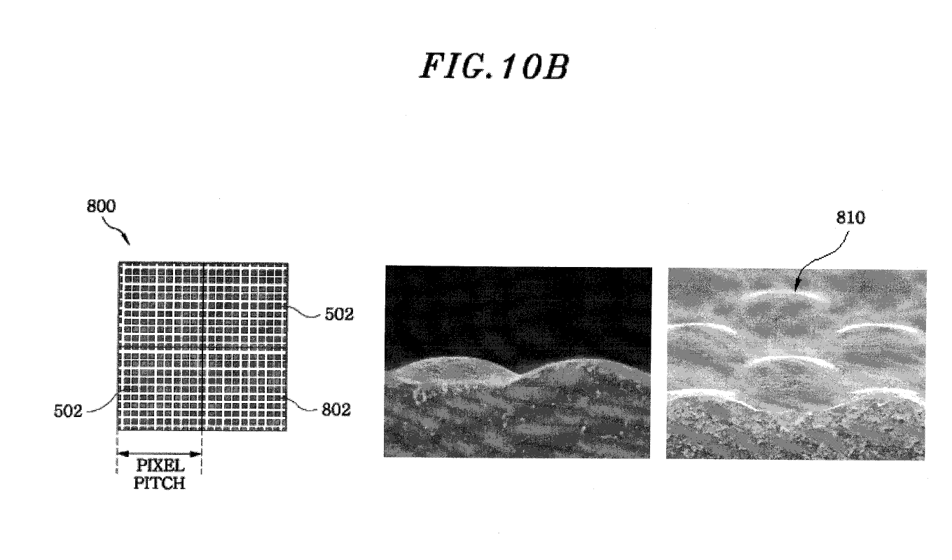

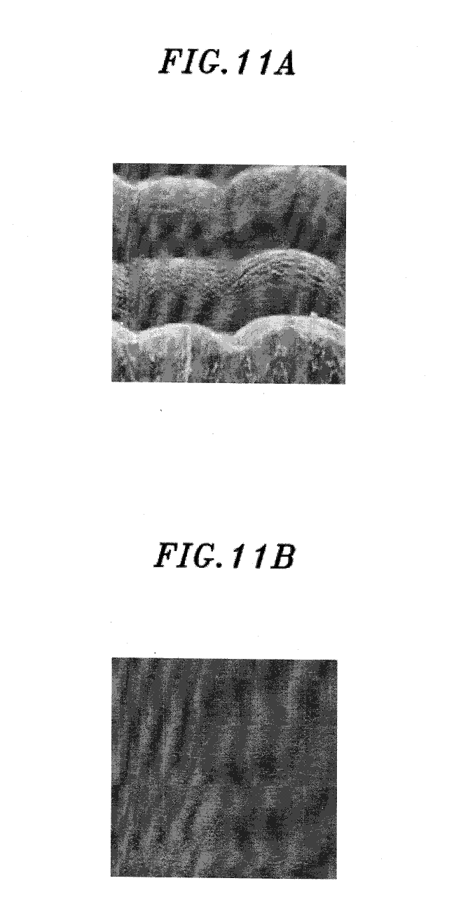

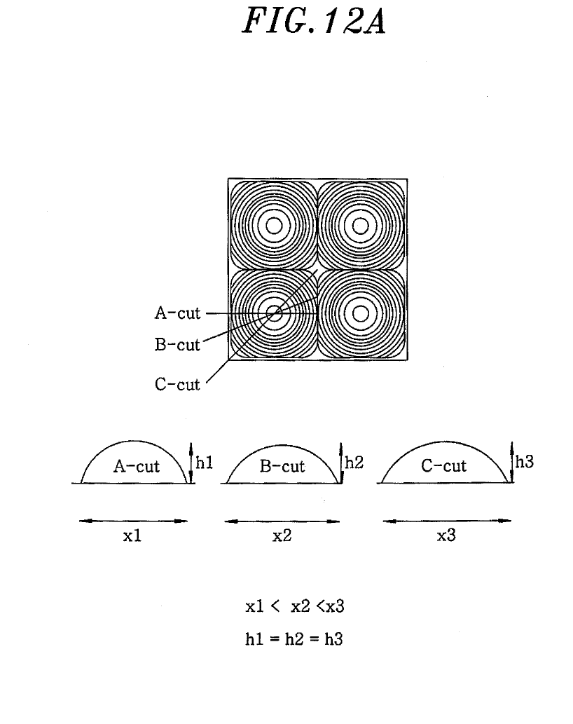

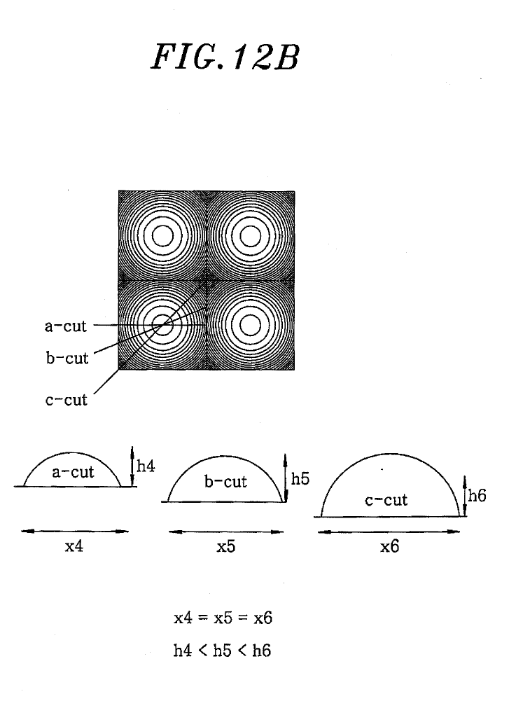

Generally, a lens-to-lens gap profile rounding generated when a micro-lens array is formed using a gray-tone mask stems from the shortage of resolution in accordance with an exposure wavelength, and thus, can be basically resolved by performing the 2-step micro-lens forming process of FIG. 1A using the gray tone mask as illustrated in example FIGS. 4A and 4B.

As illustrated in example FIG. 4A, namely, in the 2-step micro-lens process using the gray tone mask, first micro-lenses 400 are formed using a first gray tone mask on and/or over a semiconductor substrate.

As illustrated in example FIG. 4B, then second micro-lenses 402 are formed using a second gray tone mask in an empty space between the first micro-lenses 400 which have been formed through the first gray tone mask. Thus, a zero gap is achieved between the micro-lenses, thereby implementing zero dead zone micro-lenses.

Example FIG. 5A illustrates an example of a photo mask 500 used in the process of example FIGS. 4A and 4B. Gray tone masks 502 are formed at an area in which a micro-lens array is formed, on and/or over the semiconductor substrate. Blocking films 504 are formed with chromium (Cr) pads in diagonal areas in which a micro-lens array is not formed to prevent the transmission of light.

After the first micro-lenses are formed on and/or over the photo-resist film applied to the semiconductor substrate using the gray tone masks 502, second gray tone masks are formed in the areas in which the blocking films 504 have been formed with the chromium pads. Blocking films are then formed by using the chromium pads in the previous gray tone mask areas. Thereafter, the second micro-lenses are formed in the diagonal areas of the first micro-lenses using the second gray tone masks on and/or over the semiconductor substrate, thereby forming a micro-lens array with a zero dead zone.

As illustrated in example FIGS. 5A and 5B, however, when the micro-lenses are fabricated by completely preventing a light transmission through the blocking films formed with the chromium pads or the like in the areas where a micro-lens is not formed, a conic profile 600 is formed to have a shape similar to a hexahedral shape as if an upper portion of a spherical surface was cut away. This occurs instead of obtaining micro-lenses having an initially anticipated spherical surface, as illustrated in the SEM photograph of example FIG. 6. With such experimentation results, the cause can be estimated through an intensity profile obtained from an optical simulation illustrated in example FIG. 7B.

As illustrated in example FIG. 7A, the photo mask 500 in which the gray tone masks 502 are formed in the area of the semiconductor substrate in which the micro-lens array is formed. The blocking films are then formed with the chromium pads 504 in the diagonal areas in which a micro-lens array is not formed in order to prevent the transmission of light. When light is irradiated to the photo mask 500 having the configuration illustrated in example FIG. 7A, light irradiated to the chromium pads 504 is diffracted at the edges of the chromium pads 504 to have an effect that the light is additionally irradiated to the areas of the gray tone masks 502. Accordingly, the intensity profile of light applied to the lower side of the gray tone masks 502 is affected by light diffracted from the areas of the chromium pads 504. This results in the formation of the conic profile in a shape as illustrated in example FIG. 7B. When an exposing process, therefore, is performed in the state in which the intensity profile is formed, such an intensity profile is wholly transferred to the photo resist to thereby form the micro-lenses having the conic profile 600 as illustrated in the SEM photograph of example FIG. 6.

In order to solve this problem, it is required to prevent the occurrence of the diffraction phenomenon in the chromium pads on the photo mask. As illustrated in example FIG. 8A, in accordance with embodiments of the present invention, therefore, in order to prevent the diffraction by the chromium pads on the photo mask, the portions in which the chromium pads have been formed on and/or over the photo mask 800, are formed as gray dummy masks 802 in the same manner as that of the gray tone masks 502.

In such a case, the gray dummy masks 802 are formed to include certain dummy patterns having a dot size of the resolution or lower of a gray lens site, and the density of the dots can be measured by obtaining curved line data representing a change in the thickness of the photo-resist to the change in the mask chromium density as illustrated in example FIG. 9.

As illustrated in example FIG. 9, which illustrates the change in the thickness of the photo-resist the change in the chromium density, it can be seen that the thickness of the photo-resist is linearly changed only in a particular chromium density section between values “a” and “b.” Meaning, when the chromium density is less than value “a,” the thickness of the photo-resist is uniform as a maximum value, and when the density is larger than value “b,” the thickness of the photo-resist is uniform as a minimum value. In this case, preferably, value “a” may range from 20% to 30% and the value “b” may range from 60% to 80%.

In a case where a negative resist is used for the mask chromium pad illustrated in example FIG. 7A, it serves to prevent a formation of resist as described above. When the chromium density is larger than value “b” in the graph showing the change in the thickness of the photo-resist illustrated in example FIG. 9, therefore, the thickness of the photo-resist may be equal to that of a non-pattern site (or a non-pattern area) in which the chromium pad is present as illustrated in example FIG. 7A. Accordingly, when the gray dummy masks 802 including small gray dots to make the chromium density of value “b” are formed instead of the chromium pads, an intensity level equal to the lowermost intensity level can be formed in the chromium pad areas.

In this manner, when the gray dummy masks 802 including the small gray dots to make the chromium density of value “b” are formed instead of the chromium pads and then subject to an optical simulation, it can be confirmed that the intensity profile of light with respect to the micro-lens formation area is enhanced to be similar to the lens spherical surface anticipated in the micro-lens pattern as illustrated in example FIG. 8B.

As illustrated in example FIG. 10A, in a case of using the photo mask 500 in which the areas where a micro-lens is not formed are formed as the chromium pads, the diffraction of light generated from the chromium pad areas affects the micro-lens areas to make the micro-lenses formed to have a conic profile 600. On the contrary, in case of using the photo mask 800 in which the areas where a micro-lens is not formed are formed as the gray dummy masks 802, the diffraction of light is not generated in the areas of the gray dummy masks 802. Consequently, the areas of the micro-lenses are not affected by the diffraction of light, so that the micro-lenses are formed to have the spherical surface shape 810 as anticipated as illustrated in example FIG. 10B.

Considering the foregoing results, when the micro-lenses are implemented by using the 2-step micro-lens forming process using the gray tone mask, if the non-pattern area is mounted with the chromium pad (in case of a negative resist) or with a clear window (in case of a positive resist), the hexahedral conic profile is obtained. Thus, it needs to be necessarily processed with the gray dummy mask, having a certain density, including small dot patterns having the size of about gray dots. In this case, the density of the gray dots in the gray dummy mask can be determined as the chromium density in an area having a minimized thickness of the photo-resist, whereby the minimized thickness of the photo-resist can be experimentally measured through the graph of the thickness of the photo-resist to the change in the chromium density as illustrated in example FIG. 9.

As illustrated in example FIG. 11A, the SEM photographs illustrated confirm that, unlike the existing 2-step micro-lens forming process using the thermal reflow, the four pixels of the respective colors are implemented to have different lens curvatures. This is one of the most important points different from the existing 2-step micro-lens forming process. In case of the micro-lens forming process using the gray tone mask, the optimum curvature of each pixel can be implemented by differentiating the change in the gray dot density on the mask of each pixel. Meanwhile, in the top view of the SEM photograph illustrated in example FIG. 11B and the tilt view of the SEM photograph illustrated in example FIG. 11A, it can be noted that a dead zone in the 2-step micro-lens forming process using the existing thermal reflow is not definite. This is because a dead zone is formed to have a gentle curvature rather than having such a punched form as in the existing thermal reflow, due to the characteristics of the micro-lens process using the gray tone mask, thus substantially implementing a zero dead zone.

Example FIG. 12A illustrates SEM photographs of micro-lenses formed through the thermal reflow process and radiuses of the micro-lenses cut in various directions. The curvature radiuses of the micro-lenses formed through the thermal reflow process depending on a horizontal cut (A-cut), a first diagonal cut (B-cut), and a second diagonal cut (C-cut) are different from one another.

As illustrated in example FIG. 12B, on the other hand, in the SEM photographs of the micro-lenses formed through the gray-tone mask process and the radiuses of the micro-lenses cut in various directions, it can be seen that the curvature radiuses of the micro-lenses formed through the gray-tone mask process are uniform although the micro-lenses are cut in any directions. Meaning, it can be seen that the curvature radiuses of the micro-lenses formed through the gray-tone mask process depending on the horizontal cut (a-cut), the first diagonal cut (b-cut), and the second diagonal cut (c-cut) are uniform, but the heights h4, h5, and h6 from the lower layer are different from one another.

As described above, according to the method for forming a micro-lens of an image sensor in accordance with embodiments of the present invention, the gray-tone mask is designed by two steps and subject to an exposing process two times to form the micro-lenses. Accordingly, the dead zone can be enhanced when compared with that of the micro-lenses formed using the conventional thermal reflow and the curvature of each pixel of the micro-lenses can be freely adjusted. Further, the formation of the micro-lenses using the gray-tone mask does not require such a bleaching and hard baking process as in the conventional thermal reflow, simplifying the process.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for fabricating a micro-lens, the method comprising:
forming a photo-resist film on a micro-lens formation area of a semiconductor substrate;
forming a portion of the photo-resist film as a first micro-lens using a first gray-tone mask; and then
forming the remaining portion of the photo-resist film as a second micro-lens adjacent to the first micro-lens using a second gray-tone mask.

2. The method of claim 1, wherein the first gray-tone mask includes a transmission area for allowing a transmission of light to the photo-resist film.

3. The method of claim 2, wherein the first gray-tone mask includes a blocking area for blocking light.

4. The method of claim 3, wherein the density of the blocking area ranges from about 20% to 80%.

5. The method of claim 4, wherein the blocking area is formed of chromium.

6. The method of claim 5, wherein the second gray-tone mask includes a transmission area for allowing a transmission of light to the photo-resist film.

7. The method of claim 6, wherein the second gray-tone mask includes a blocking area for blocking light.

8. The method of claim 7, wherein the density of the blocking area ranges from about 20% to 80%.

9. The method of claim 8, wherein the blocking area is formed of chromium.

10. The method of claim 9, wherein the curvature radius of the first micro-lens is different from that of the second micro-lens.

11. The method of claim 9, wherein the curvature radius of a horizontal cut and the curvature of a diagonal cut of each of the first and second micro-lenses are equal.

12. The method of claim 11, wherein the height from a lower layer of the horizontal cut and the height from the lower layer of the diagonal cut are different from each other.

13. The method of claim 9, wherein the first micro-lens and the second micro-lens are formed to be adjacent in a vertical direction.

14. The method of claim 9, wherein the first micro-lens and the second micro-lens are formed to be adjacent in a horizontal direction.

15. A method for fabricating a micro-lens, the method comprising:
forming a photo-resist film on a semiconductor substrate;
forming a first micro-lens on the semiconductor substrate using a first portion of the photo-resist film and a first gray-tone mask; and then
forming a second micro-lens on the semiconductor substrate and adjacent to the first micro-lens using a second portion of the photo-resist film and a second gray-tone mask.

16. The method of claim 15, wherein the first gray-tone mask and the second gray-tone mask each include:
a transmission area for allowing a transmission of light to the photo-resist film; and
a blocking area for blocking light, the blocking area having a density ranging from about 30% to 60%.

17. A micro-lens array for an image sensor, the micro-lens array comprising:
a first micro-lens; and
a second micro-lens adjacent to the first micro-lens and having a curvature radius different from that of the first micro-lens.

18. The micro-lens array of claim 17, wherein the first micro-lens and the second micro-lens are each formed adjacent to each other in one of a vertical direction and a horizontal direction.

19. The micro-lens array of claim 18, wherein the curvature radius of a horizontal cut and the curvature radius of a diagonal cut of each of the first micro-lens and the second micro-lens are equal.

20. The micro-lens array of claim 19, wherein the height from a lower layer of the horizontal cut and the height from a lower layer of the diagonal cut are different from each other.
